(19) United States
(12) Patent Application Publication
(10) Pub. No.: US 2018/0119017 A1
(43) Pub. Date: May 3, 2018

(54) METHOD FOR PRODUCING FLAME-RETARDANT, NONCORROSIVE, AND STABLE POLYAMIDE MOLDING COMPOSITIONS

(71) Applicant: CLARIANT PLASTICS & COATINGS LTD, Muttenz (CH)

(72) Inventors: Elke SCHLOSSER, Augsburg (DE); Sebastian HOEROLD, Diedorf (DE)

(73) Assignee: CLARIANT PLASTICS & COATINGS LTD, Muttenz (CH)

(21) Appl. No.: 15/565,638

(22) PCT Filed: Apr. 4, 2016
(86) PCT No.: PCT/EP2016/057313

§ 371 Date: Oct. 10, 2017

(30) Foreign Application Priority Data
Apr. 13, 2015 (DE) 10 2015 004 662.4

(51) Int. Cl. C09K 21/12; C09K 21/04; C09K 15/02; C08K 5/5313; C08K 5/5317; C08K 3/38; C08K 3/22

(52) U.S. Cl. CPC C09K 21/12; C09K 21/04; C09K 15/02; C08K 5/5313; C08K 5/5317; C08K 2003/2227; C08K 3/22; C08K 2003/2296; C08K 2003/2231; C08K 2003/387; C08K 3/38

(57) ABSTRACT

Subject matter of the invention is the use of a mixture of a plurality of components as a noncorrosive flame retardant, the mixture comprising
as component A) 20 to 98.9 wt % of a dialkylphosphinic salt of the formula (I) and/or of a diphosphinic salt of the formula (II) and/or polymers thereof,

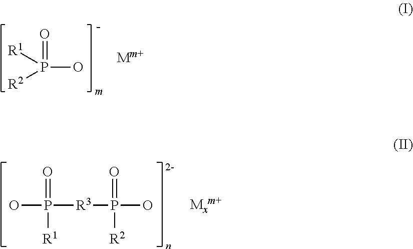

in which
R¹, R² are identical or different and are C₁-C₆-alkyl, linear or branched;
R³ is C₁-C₁₀-alkylene, linear or branched, C₆-C₁₀-arylene, C₇-C₂₀-alkylarylene or C₇-C₂₀-arylalkylene;
M is Mg, Ca, Al, Sb, Sn, Ge, Ti, Zn, Fe, Zr, Ce, Bi, Sr, Mn, Li, Na, K and/or a protonated nitrogen base;
m is 1 to 4;
n is 1 to 4;
x is 1 to 4,
as component B) 1 to 80 wt % of a salt of phosphorous acid having the formula (III)

[HP(═O)O₂]²⁻M^{m+}
in which
M is Mg, Ca, Al, Sb, Sn, Ge, Ti, Zn, Fe, Zr, Ce, Bi, Sr, Mn, Li, Na and/or K,
as component C) 0.1 to 30 wt % of an inorganic zinc compound,
as component D) 0 to 30 wt % of a nitrogen-containing synergist and/or a phosphorus/nitrogen flame retardant,
as component E) 0 to 3 wt % of a phosphonite or of a mixture of a phosphonite and a phosphite, and
as component F) 0 to 3 wt % of an ester or salt of long-chain aliphatic carboxylic acids (fatty acids), which typically have chain lengths of C₁₄ to C₄₀,
the sum of the components always being 100 wt %.

The invention relates to a method for producing flame-retardant, noncorrosive, and stable polyamide molding compositions, and also to these compositions themselves.

For thermoplastic polymers in particular, the salts of phosphinic acids (phosphinates) have proven effective flame-retardant additives (DE-A-2252258 and DE-A-2447727). Calcium and aluminum phosphinates have been described as particularly effective in their activity in polyesters, and have less of an adverse effect on the engineering properties of the polymer molding compositions than, for example, the alkali metal salts (EP-A-0699708). Furthermore, synergistic combinations of phosphinates with certain nitrogen-containing compounds have been found which act more effectively as flame retardants across a whole range of polymers than do the phosphinates on their own (PCT/EP97/01664 and also DE-A-19734437 and DE-A-19737727).

DE-A-19614424 describes phosphinates in conjunction with nitrogen synergists in polyesters and polyamides. DE-A-19933901 describes phosphinates in combination with melamine polyphosphate as flame retardants for polyesters and polyamides. When these very effective flame retardants are used, however, there may be partial polymer degradation and also instances of polymer discoloration, especially at processing temperatures above 300° C., and there may be instances of efflorescence on storage under hot-humid conditions.

Thermoplastics are processed predominantly in the melt. Hardly any plastic withstands the associated changes in structure and physical state under thermal and shearing exposure without undergoing alteration in its chemical structure. Crosslinking, oxidation, changes in molecular weight, and hence also changes in the physical and technical properties may be the consequence. In order to lessen the burden on the polymers during processing, additives are added which vary according to the plastic in question.

Through the use of flame retardants there may be additional destabilization during processing in the melt. Flame retardants must often be added at high rates in order to ensure sufficient flame retardancy of the plastic in accordance with international standards. The chemical reactivity of flame retardants, which they need for the flame retardancy effect at high temperatures, may result in them adversely affecting the processing stability of plastics. For example, there may be increased polymer degradation, crosslinking reactions, outgassing or discoloration.

The incorporation of flame retardants, particularly of phosphinates, may cause increased wear to processing machines, such as extruders and injection molding machines, for example. Parts particularly affected may be metal parts of the plastifying unit and of the die during compounding and/or injection molding. The higher the processing temperature of the polymers, the greater the rate at which wear may occur.

Generally speaking, hard fillers (such as glass fibers) together with corrosive elimination products (from flame retardants, for instance) lead to wear to metallic surfaces of tooling. Depending on the quality of material of the metallic surfaces and on the plastics used, this wear necessitates relatively frequent replacement of heating jackets in the conveying unit, of the conveying screw, and of the injection molds. Since glass fiber-reinforced thermoplastic polymers are abrasive, there are limits to the possibilities of protecting the conveying screws from corrosion, since highly corrosion-resistant steels do not have the hardness needed for the processing of glass fiber-reinforced polymers.

Corrosion according to DIN EN ISO 8044 is the physicochemical interaction between a metal and its environment, with the possible consequence of alteration to the properties of the metal and thus of considerable impairment of the function of the metal, of the environment, or of the technical system of which the metal forms a part.

WO-A-2009/109318 describes methods for producing flame-retardant, noncorrosive and readily flowable polyamide and polyester molding compositions. A variety of additives can be used to reduce, but not prevent, the corrosion and/or the wear caused by flame retardants.

US-A-2010/0001430 describes a flame-retarded semiaromatic polyamide with zinc stannate, which exhibits a much-reduced corrosiveness. Even here, nevertheless, a certain level of wear is measurable.

DE-A-102010048025 describes flame retardant/stabilizer combinations for thermoplastic polymers that exhibit high flame retardancy with good mechanical properties and at the same time exhibit no discoloration or efflorescence due to polymer degradation and decomposition reactions. It is noted that the flame retardant/stabilizer combination exhibits low corrosion.

It was an object of the present invention, accordingly, to provide flame-retarded polyamides which with halogen-free flame retardant exhibit high stability, good mechanical properties, and no measurable wear when they are processed.

This object is achieved through the use of a mixture of a salt of a dialkylphosphinic acid (component A)) with a salt of phosphorous acid (also called phosphonic acid) HP(═O)(OH)₂ (component B) and also with a zinc-containing adjuvant (component c)).

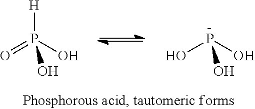

Subject matter of the invention is therefore the use of a mixture of a plurality of components as a noncorrosive flame retardant, the mixture comprising

as component A) 20 to 98.9 wt % of a dialkylphosphinic salt of the formula (I) and/or of a diphosphinic salt of the formula (II) and/or polymers thereof,

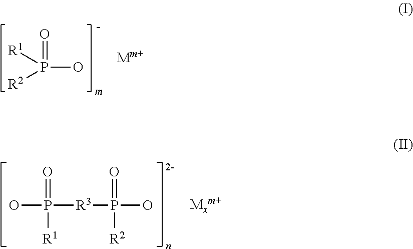

in which
R¹, R² are identical or different and are C₁-C₆-alkyl, linear or branched;
R³ is C₁-C₁₀-alkylene, linear or branched, C₆-C₁₀-arylene, C₇-C₂₀-alkylarylene or C₇-C₂₀-arylalkylene;
M is Mg, Ca, Al, Sb, Sn, Ge, Ti, Zn, Fe, Zr, Ce, Bi, Sr, Mn, Li, Na, K and/or a protonated nitrogen base;
m is 1 to 4;
n is 1 to 4;
x is 1 to 4,
   as component B) 1 to 80 wt % of a salt of phosphorous acid having the formula (III)

[HP(═O)O₂]²⁻M^{m+}(III)

in which
M is Mg, Ca, Al, Sb, Sn, Ge, Ti, Zn, Fe, Zr, Ce, Bi, Sr, Mn, Li, Na and/or K,
as component C) 0.1 to 30 wt % of an inorganic zinc compound,
as component D) 0 to 30 wt % of a nitrogen-containing synergist and/or a phosphorus/nitrogen flame retardant,
as component E) 0 to 3 wt % of a phosphonite or of a mixture of a phosphonite and a phosphite, and
as component F) 0 to 3 wt % of an ester or salt of long-chain aliphatic carboxylic acids (fatty acids), which typically have chain lengths of C₁₄ to C₄₀,
the sum of the components always being 100 wt %.

Preferably R¹, R² in formula (I) and (II) are identical or different and are methyl, ethyl, n-propyl, isopropyl, n-butyl, tert-butyl, n-pentyl and/or phenyl.

Preferably R³ is methylene, ethylene, n-propylene, isopropylene, n-butylene, tert-butylene, n-pentylene, n-octylene or n-dodecylene; phenylene or naphthylene; methylphenylene, ethylphenylene, tert-butylphenylene, methylnaphthylene, ethylnaphthylene or tert-butylnaphthylene; phenylmethylene, phenylethylene, phenylpropylene or phenylbutylene.

Preferably the mixture comprises

60 to 89.8 wt % of component A),
10 to 40 wt % of component B),
0.1 to 20 wt % of component C),
0 to 20 wt % of component D),
0 to 2 wt % of component E) and
0.1 to 2 wt % of component F).

Preferably the mixture also comprises

60 to 84.9 wt % of component A),
10 to 40 wt % of component B),
5 to 20 wt % of component C),
0 to 10 wt % of component D),
0 to 2 wt % of component E) and
0.1 to 2 wt % of component F).

More preferably the mixture comprises

60 to 84.8 wt % of component A),
10 to 40 wt % of component B),
5 to 20 wt % of component C),
0 to 10 wt % of component D),
0.1 to 2 wt % of component E) and
0.1 to 2 wt % of component F).

With more particular preference the mixture comprises

60 to 83.8 wt % of component A),
10 to 40 wt % of component B),
5 to 20 wt % of component C),
1 to 10 wt % of component D),
0.1 to 2 wt % of component E) and
0.1 to 2 wt % of component F).

Preferably component B comprises reaction products of phosphorous acid with aluminum compounds.

More preferably component B comprises aluminum phosphite [Al(H₂PO₃)₃], secondary aluminum phosphite [Al₂(HPO₃)₃], basic aluminum phosphite [Al(OH)(H₂PO₃)₂*2aq], aluminum phosphite tetrahydrate [Al₂(HPO₃)₃*4aq], aluminum phosphonate, Al₇(HPO₃)₉(OH)₆(1,6-hexanediamine)_{1.5}*12H₂O, Al₂(HPO₃)³xAl₂O₃*nH₂O with x=1-2.27 and n=1-50 and/or Al₄H₆P₁₆O₁₈, or comprises aluminum phosphites of the formulae (XII), (XIII) and/or (XIV), where

formula (XII) comprises: Al₂(HPO₃)₃x(H₂O)_{q}

and
q is 0 to 4;

formula (XIII) comprises Al_{2.00}M_{z}(HPO₃)_{y}(OH)ᵥx(H₂O)_{w}

and
M is alkali metal ions,
z is 0.01 to 1.5,
y is 2.63 to 3.5,
v is 0 to 2, and
w is 0 to 4;

formula (XIV) comprises Al_{2.00}(HPO₃)ᵤ(H₂PO₃)ₜx(H₂O)ₛ

and
u is 2 to 2.99 and
t is 2 to 0.01 and
s is 0 to 4,
or the aluminum phosphite comprises mixtures of aluminum phosphite of the formula (XII) with sparingly soluble aluminum salts and nitrogen-free foreign ions, mixtures of aluminum phosphite of the formula (XIII) with aluminum salts, mixtures of aluminum phosphites of the formulae (XII) to (XIV) with aluminum phosphite [Al(H₂PO₃)₃], with secondary aluminum phosphite [Al₂(HPO₃)₃], with basic aluminum phosphite [Al(OH)(H₂PO₃)₂*2aq], with aluminum phosphite tetrahydrate [Al₂(HPO₃)₃*4aq], with aluminum phosphonate, with Al₇(HPO₃)₉(OH)₆(1,6-hexanediamine)_{1.5}*12H₂O, with Al₂(HPO₃)₃*xAl₂O₃*nH₂O with x=1-2.27 and n=1-50 and/or with Al₄H₆P₁₆O₁₈.

Preferably component C) comprises zinc oxide, zinc hydroxide, tin oxide hydrate, zinc borate, basic zinc silicate and/or zinc stannate.

Preferably component D) comprises condensation products of melamine and/or reaction products of melamine with polyphosphoric acid and/or reaction products of condensation products of melamine with polyphosphoric acid, or mixtures thereof; or comprises melem, melam, melon, dimelamine pyrophosphate, melamine polyphosphate, melem polyphosphate, melam polyphosphate, melon polyphosphate and/or mixed polysalts thereof; or comprises nitrogen-containing phosphates of the formulae (NH₄)_{y} H_{3-y} PO₄ and/or (NH₄ PO₃)_{z}, where y is 1 to 3 and z is 1 to 10000.

Preferably the phosphonites (component E)) are of the general structure

R—[P(OR₁)₂]ₘ (IV)

where
R is a mono- or polyvalent aliphatic, aromatic or heteroaromatic organic radical and
R₁ is a compound of the structure (V)

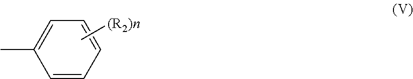

or the two radicals R₁ form a bridging group of the structure (VI)

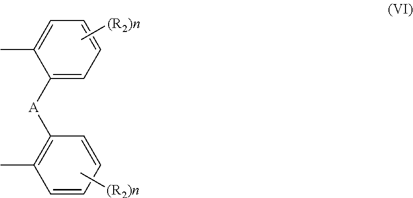

where
A is direct bond, O, S, C₁-C₁₈-alkylene (linear or branched), C₁-C₁₈-alkylidene (linear or branched),
   in which
R₂ independently at each occurrence is C₁-C₁₂-alkyl (linear or branched), C₁-C₁₂-alkoxy, C₅-C₁₂-cycloalkyl, and
n is 0 to 5, and
m is 1 to 4.

Preferably component F) comprises alkali metal, alkaline earth metal, aluminum and/or zinc salts of long-chain fatty acids having 14 to 40 carbon atoms and/or reaction products of long-chain fatty acids having 14 to 40 carbon atoms with polyhydric alcohols, such as ethylene glycol, glycerol, trimethylolpropane and/or pentaerythritol.

The invention also relates to the use of the mixture of a plurality of components as claimed in one or more of claims 1 to 13, wherein the mixture of a plurality of components is incorporated into a polymer.

Preferably the polymer comprises polyesters, polyamides and/or polymer blends which comprise polyamides or polyesters.

More preferably the polymer comprises one or more polyamides, which may have been furnished with fillers and/or reinforcing agents.

The polyamides are preferably in the form of moldings, films, filaments and/or fibers.

The inventive use preferably comprises a composition of

30-93 wt % of polyamide
2-40 wt % of the mixture of the plurality of components A) to F)
5-50 wt % of fillers and/or reinforcing agents
0-40 wt % of other additions.

Surprisingly it has been found that combinations, according to the invention, of salts of dialkylphosphinic acids and salts of phosphorous acid with zinc-containing adjuvants exhibit high flame retardancy in combination with improved stability in the processing of the molding compositions. This effect of corrosion prevention was not hitherto described in the prior art to this extent.

More preferably component C) comprises zinc stannate and/or zinc borate.

Preferably component E) comprises phosphonites or a mixture of a phosphonite and a phosphite.

Preferred salts of phosphorous acid (component B)) are salts which are sparingly soluble or insoluble in water.

Particularly preferred salts of phosphorous acid are aluminum, calcium, and zinc salts.

More preferably component B) is a reaction product of phosphorous acid and an aluminum compound.

Preferred are aluminum phosphites with the CAS numbers 15099-32-8, 119103-85-4, 220689-59-8, 56287-23-1, 156024-71-4, 71449-76-8, and 15099-32-8.

Preferred are aluminum phosphites of type Al₂(HPO₃)₃*0.1-30 Al₂O₃*0-50 H₂O, more preferably Al₂(HPO₃)₃*0.2-20 Al₂O₃*0-50 H₂O, very preferably Al₂(HPO₃)₃*1-3 Al₂O₃*0-50 H₂O.

Preferred are mixtures of aluminum phosphite and aluminum hydroxide of the composition 5-95 wt % Al₂(HPO₃)₃*nH₂O and 95-5 wt % Al(OH)₃, more preferably 10-90 wt % Al₂(HPO₃)₃*nH₂O and 90-10 wt % Al(OH)₃, very preferably 35-65 wt % Al₂(HPO₃)₃*nH₂O and 65-35 wt % Al(OH)₃ and in each case n=0 to 4.

The aluminum phosphites preferably have particle sizes of 0.2 to 100 μm.

The preferred aluminum phosphites are produced customarily by reaction of an aluminum source with a phosphorus source and if desired a template in a solvent at 20 to 200° C. over a period of up to four days. For this, aluminum source and phosphorus source are mixed, heated under hydrothermal conditions or at reflux, and the solid is isolated by filtration, washed, and dried.

Preferred aluminum sources are aluminum isopropoxide, aluminum nitrate, aluminum chloride, aluminum hydroxide (e.g. pseudoboehmite).

Preferred phosphorus sources are phosphorous acid, (acidic) ammonium phosphite, alkali metal phosphites, or alkaline earth metal phosphites.

Preferred alkali metal phosphites are disodium phosphite, disodium phosphite hydrate, trisodium phosphite, potassium hydrogenphosphite.

Preferred disodium phosphite hydrate is Briggolen® H10 from Briggemann.

Preferred templates are 1,6-hexanediamine, guanidine carbonate or ammonia.

Preferred alkaline earth metal phosphite is calcium phosphite.

The preferred ratio of aluminum to phosphorus to solvent is 1:1:3.7 to 1:2.2:100 mol. The ratio of aluminum to template is 1:0 to 1:17 mol.

The preferred pH of the reaction solution is 3 to 9.

Preferred solvent is water.

Component C) is preferably zinc stannate.

Suitable components D) are also compounds of the formulae (XV) to (XX) or mixtures thereof

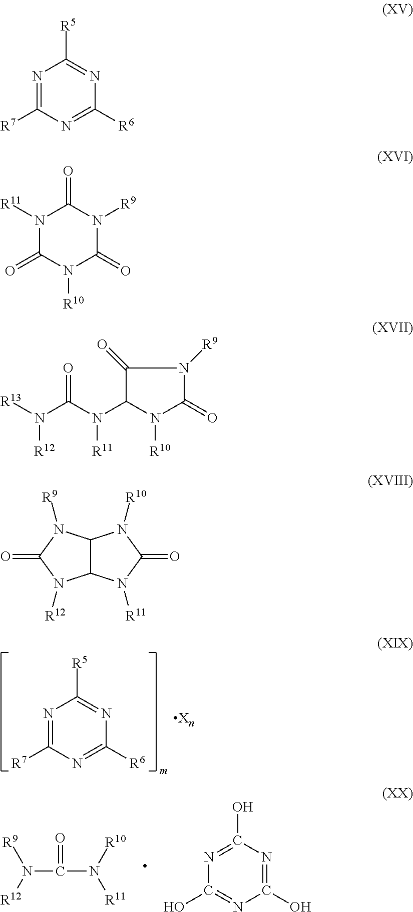

in which
R⁵ to R⁷ are hydrogen, C₁-C₈-alkyl, C₅-C₁₆-cycloalkyl or -alkylcycloalkyl, possibly substituted by a hydroxyl or by a C₁-C₄-hydroxyalkyl function, C₂-C₈-alkenyl, C₁-C₈-alkoxy, -acyl, -acyloxy, C₆-C₁₂-aryl or -arylalkyl, —OR⁸ and —N(R⁸)R⁹, and also N-alicyclic or N-aromatic,
R⁸ is hydrogen, C₁-C₈-alkyl, C₅-C₁₆-cycloalkyl or -alkylcycloalkyl, possibly substituted by a hydroxyl or by a C₁-C₄-hydroxyalkyl function, C₂-C₈-alkenyl, C₁-C₈-alkoxy, -acyl, -acyloxy or C₆-C₁₂-aryl or -arylalkyl,
R⁹ to R¹³ are the same groups as R⁸ and also —O—R⁸,
m and n independently of one another are 1, 2, 3 or 4,
X are acids which are able to form adducts with triazine compounds;
   or are oligomeric esters of tris(hydroxyethyl)isocyanurate with aromatic polycarboxylic acids.

Particularly suitable components D) are benzoguanamine, tris(hydroxyethyl)isocyanurate, allantoin, glycoluril, melamine, melamine cyanurate, dicyandiamide and/or guanidine.

Preferably M in formula (I) and (II) is calcium, aluminum or zinc.

By protonated nitrogen bases are meant preferably the protonated bases of ammonia, melamine, triethanolamine, especially NH₄⁺.

Suitable phosphinates are described in PCT/WO97/39053, which is expressly referenced.

Particularly preferred phosphinates are aluminum, calcium, and zinc phosphinates.

In the application, with particular preference, the same salt of phosphinic acid as of phosphorous acid is used—in other words, for example, aluminum dialkylphosphinate together with aluminum phosphite, or zinc dialkylphosphinate together with zinc phosphite.

The combination according to the invention, comprising the components A) and B) and C) and also optionally D), E) and F), may be admixed with additives, such as, for example, antioxidants, UV absorbers and light stabilizers, metal deactivators, peroxide-destroying compounds, polyamide stabilizers, basic costabilizers, nucleating agents, fillers and reinforcing agents, further flame retardants, and other additions.

Suitable antioxidants are, for example, alkylated monophenols, e.g. 2,6-di-tert-butyl-4-methylphenol; alkylthiomethylphenols, e.g. 2,4-dioctylthiomethyl-6-tert-butylphenol; hydroquinones and alkylated hydroquinones, e.g. 2,6-di-tert-butyl-4-methoxyphenol; tocopherols, e.g. α-tocopherol, β-tocopherol, γ-tocopherol, δ-tocopherol and mixtures thereof (vitamin E); hydroxylated thiodiphenyl ethers, e.g. 2,2′-thiobis(6-tert-butyl-4-methylphenol), 2,2′-thiobis(4-octylphenol), 4,4′-thiobis(6-tert-butyl-3-methylphenol), 4,4′-thiobis(6-tert-butyl-2-methylphenol), 4,4′-thiobis(3,6-di-sec-amylphenol), 4,4′-bis(2,6-dimethyl-4-hydroxyphenyl) disulfide; alkylidenebisphenols, e.g. 2,2′-methylenebis(6-tert-butyl-4-methylphenol);

O-, N- and S-benzyl compounds, e.g. 3,5,3′,5′-tetra-tert-butyl-4,4′-dihydroxydibenzyl ether; hydroxybenzylated malonates, e.g. dioctadecyl 2,2-bis(3,5-di-tert-butyl-2-hydroxybenzyl)malonate; hydroxybenzyl aromatics, e.g. 1,3,5-tris-(3,5-di-tert-butyl)-4-hydroxybenzyl)-2,4,6-trimethylbenzene, 1,4-bis(3,5-di-tert-butyl-4-hydroxybenzyl)-2,3,5,6-tetramethylbenzene, 2,4,6-tris-(3,5-di-tert-butyl-4-hydroxybenzyl)phenol; triazine compounds, e.g. 2,4-bisoctylmercapto-6(3,5-di-tert-butyl-4-hydroxyanilino)-1,3,5-triazine; benzylphosphonates, e.g. dimethyl 2,5-di-tert-butyl-4-hydroxybenzylphosphonate; acylaminophenols, 4-hydroxylauramide, 4-hydroxystearanilide, octyl N-(3,5-di-tert-butyl-4-hydroxyphenyl)carbamate; esters of β-(3,5-di-tert-butyl-4-hydroxyphenyl)propionic acid with mono- or polyhydric alcohols; esters of β-(5-tert-butyl-4-hydroxy-3-methylphenyl)propionic acid with mono- or polyhydric alcohols; esters of β-(3,5-dicyclohexyl-4-hydroxyphenyl)propionic acid with mono- or polyhydric alcohols; esters of 3,5-di-tert-butyl-4-hydroxyphenylacetic acid with mono- or polyhydric alcohols; amides of β-(3,5-di-tert-butyl-4-hydroxyphenyl)propionic acid, for example N,N′-bis(3,5-di-tert-butyl-4-hydroxyphenylpropionyl)hexamethylenediamine, N,N′-bis(3,5-di-tert-butyl-4-hydroxyphenylpropionyl)trimethylenediamine, N,N′-bis(3,5-di-tert-butyl-4-hydroxyphenylpropionyl)hydrazine.

Suitable UV absorbers and light stabilizers are, for example, 2-(2′-hydroxyphenyl)-benzotriazoles, for example 2-(2′-hydroxy-5′-methylphenyl)benzotriazole; 2-hydroxybenzophenones, for example the 4-hydroxy, 4-methoxy, 4-octoxy, 4-decyloxy, 4-dodecyloxy, 4-benzyloxy, 4,2′,4-trihydroxy, 2′-hydroxy-4,4′-dimethoxy derivative;

esters of optionally substituted benzoic acids, for example 4-tert-butylphenyl salicylate, phenyl salicylate, octylphenyl salicylate, dibenzoylresorcinol, bis(4-tert-butylbenzoyl)resorcinol, benzoylresorcinol, 2,4-di-tert-butylphenyl 3,5-di-tert-butyl-4-hydroxybenzoate, hexadecyl 3,5-di-tert-butyl-4-hydroxybenzoate, octadecyl 3,5-di-tert-butyl-4-hydroxybenzoate, 2-methyl-4,6-di-tert-butylphenyl 3,5-di-tert-butyl-4-hydroxybenzoate; acrylates, for example ethyl or isooctyl α-cyano-β,β-diphenylacrylate, methyl α-carbomethoxycinnamate, methyl or butyl α-cyano-β-methyl-p-methoxycinnamate, methyl α-carbomethoxy-p-methoxycinnamate, N-(β-carbomethoxy-β-cyanovinyl)-2-methylindoline.

Additionally nickel compounds, for example nickel complexes of 2,2′-thiobis[4(1,1,3,3-tetramethylbutyl)phenol], such as the 1:1 or 1:2 complex, optionally with additional ligands such as n-butylamine, triethanolamine or N-cyclohexyldiethanolamine, nickel dibutyldithiocarbamate, nickel salts of monoalkyl 4-hydroxy-3,5-di-tert-butylbenzylphosphonates, such as of the methyl or ethyl ester, nickel complexes of ketoximes, such as of 2-hydroxy-4-methylphenyl undecyl ketoxime, nickel complexes of 1-phenyl-4-lauroyl-5-hydroxypyrazole, optionally with additional ligands; sterically hindered amines, for example bis(2,2,6,6-tetramethylpiperidyl) sebacate; oxalamides, for example 4,4′-dioctyloxyoxanilide; 2-(2-hydroxyphenyl)-1,3,5-triazines, for example 2,4,6-tris(2-hydroxy-4-octyloxyphenyl)-1,3,5-triazine.

Suitable metal deactivators are, for example, N,N′-diphenyloxalamide, N-salicylal-N′-salicyloylhydrazine, N,N′-bis(salicyloyl)hydrazine, N,N′-bis(3,5-di-tert-butyl-4-hydroxyphenylpropionyl)hydrazine, 3-salicyloylamino-1,2,4-triazole, bis(benzylidene)oxalyl dihydrazide, oxanilide, isophthaloyl dihydrazide, sebacoyl bisphenylhydrazide, N,N′-diacetyladipoyl dihydrazide, N,N′-bis(salicyloyl)oxaloyl dihydrazide, N,N′-bis(salicyloyl)thiopropionyl dihydrazide.

Suitable peroxide-destroying compounds are, for example, esters of β-thiodipropionic acid, for example the lauryl, stearyl, myristyl or tridecyl ester, mercaptobenzimidazole, the zinc salt of 2-mercaptobenzimidazole, zinc dibutyldithiocarbamate, dioctadecyl disulfide, pentaerythrityl tetrakis(β-dodecylmercapto)propionate.

Suitable polyamide stabilizers are, for example, copper salts in combination with iodides and/or phosphorus compounds, and salts of divalent manganese.

Suitable basic costabilizers are melamine, polyvinylpyrrolidone, dicyandiamide, triallyl cyanurate, urea derivatives, hydrazine derivatives, amines, polyamides, polyurethanes, alkali metal and alkaline earth metal salts of higher fatty acids, for example calcium stearate, zinc stearate, magnesium behenate, magnesium stearate, sodium ricinoleate, potassium palmitate, antimony pyrocatecholate or tin pyrocatecholate.

Suitable nucleating agents are, for example, 4-tert-butylbenzoic acid, adipic acid and diphenylacetic acid.

The fillers and reinforcing agents include, for example, calcium carbonate, silicates, glass fibers, asbestos, talc, kaolin, mica, barium sulfate, metal oxides and hydroxides, carbon black, graphite, and others.

Suitable further flame retardants are, for example, aryl phosphates, phosphonates, salts of hypophosphorous acid, and red phosphorus.

The other additives include, for example, plasticizers, expandable graphite, lubricants, emulsifiers, pigments, optical brighteners, flame retardants, antistats, blowing agents.

These additional additives can be added to the polymers before, together with or after addition of the flame retardants. These additives, and also the flame retardants, can be metered in as a solid, in solution or as a melt, or else in the form of solid or liquid mixtures or as masterbatches/concentrates.

In the phosphonites, preference is given to the following radicals:
R is C₄-C₁₈-alkyl (linear or branched), C₄-C₁₈-alkylene (linear or branched), C₅-C₁₂-cycloalkyl, C₅-C₁₂-cycloalkylene, C₆-C₂₄-aryl or -heteroaryl, C₆-C₂₄-arylene or -heteroarylene, which may also have further substitution;
R₁ is a compound of the structure (V) or (VI) where
R₂ is independently C₁-C₈-alkyl (linear or branched), C₁-C₈-alkoxy, -cyclohexyl;
A is a direct bond, O, C₁-C₈-alkylene (linear or branched), C₁-C₈-alkylidene (linear or branched) and
n is 0 to 3
m is 1 to 3.

In the phosphonites, particular preference is given to the following radicals:
R is cyclohexyl, phenyl, phenylene, biphenylyl and biphenylene
R₁ is a compound of the structure (V) or (VI) where
R₂ is independently C₁-C₈-alkyl (linear or branched), C₁-C₈-alkoxy, cyclohexyl
A is a direct bond, O, C₁-C₆-alkylidene (linear or branched) and
n is 1 to 3
m is 1 or 2.

Additionally claimed are mixtures of compounds according to the above claims in combination with phosphites of the formula (VII)

P(OR₁)₃ (VII)

where R₁ is as defined above.

Especially preferred are compounds which, based on the above information, are prepared by a Friedel-Crafts reaction of an aromatic or heteroaromatic, such as benzene, biphenyl or diphenyl ether, with phosphorus trihalides, preferably phosphorus trichloride, in the presence of a Friedel-Crafts catalyst such as aluminum chloride, zinc chloride, iron chloride, etc. and subsequent reaction with the parent phenols of the structures (V) and (VI). Explicitly included are also those mixtures with phosphites which form after the reaction sequence stated from excess phosphorus trihalide and the above-described phenols.

From this group of compounds, preference is given in turn to the following structures (VIII) and (IX):

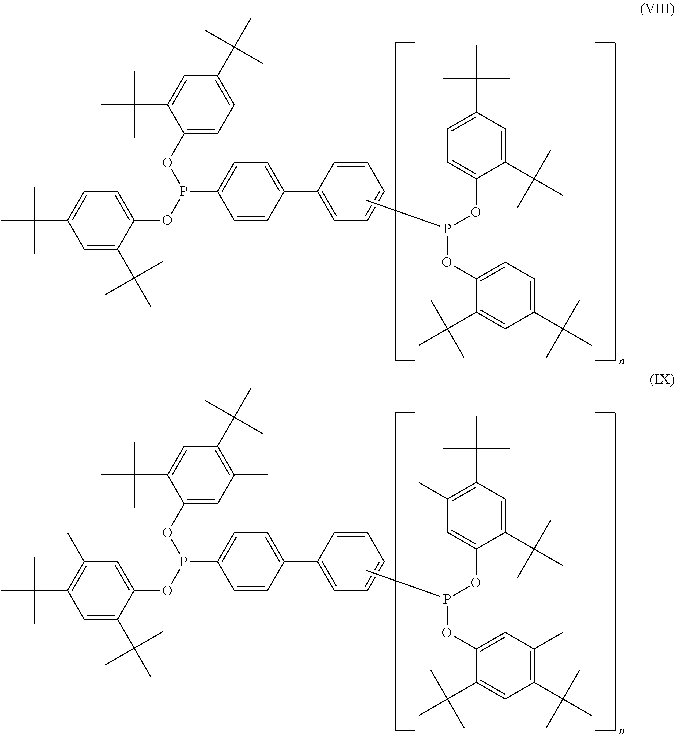

where n may be 0 or 1 and these mixtures may optionally further comprise proportions of the compound (X) or (XI):

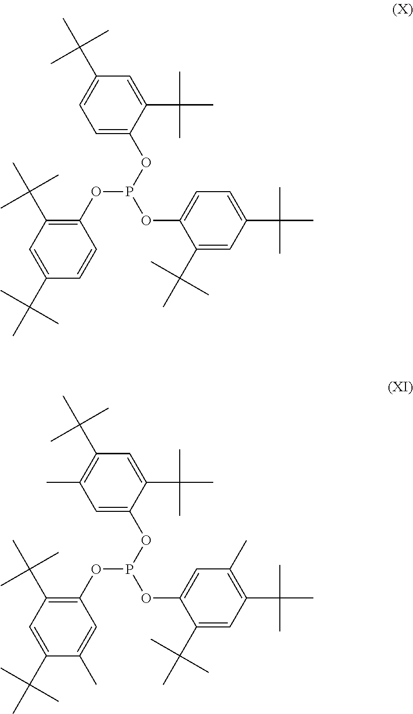

Suitable components F) are esters or salts of long-chain aliphatic carboxylic acids (fatty acids), which typically have chain lengths of C₁₄ to C₄₀. The esters are reaction products of the carboxylic acids mentioned with commonly used polyhydric alcohols, for example ethylene glycol, glycerol, trimethylolpropane or pentaerythritol. Useful salts of the carboxylic acids mentioned include in particular alkali metal or alkaline earth metal salts, or aluminum and zinc salts.

Component F) preferably comprises esters or salts of stearic acid, for example glyceryl monostearate or calcium stearate.

Component F) preferably comprises reaction products of montan wax acids with ethylene glycol.

The reaction products are preferably a mixture of ethylene glycol mono-montan wax ester, ethylene glycol di-montan wax ester, montan wax acids, and ethylene glycol.

Component F) preferably comprises reaction products of montan wax acids with a calcium salt.

The reaction products are more preferably a mixture of 1,3-butanediol mono-montan wax ester, 1,3-butanediol di-montan wax ester, montan wax acids, 1,3-butanediol, calcium montanate, and the calcium salt.

The proportions of the components A), B), and C) in the flame retardant combination are dependent substantially on the intended field of application, and may vary within wide limits. According to the field of application, the flame retardant combination comprises 20 to 98.9 wt % of component A), 1 to 80 wt % of component B), and 0.1 to 30 wt % of component C). Component D) is added at 0 to 30 wt %, and components E) and F) are added independently of one another at 0 to 3 wt %.

The flame retardant/stabilizer combination is used preferably in the polyamide molding composition in a total amount of 2 to 50 wt %, based on the polymeric molding composition. The amount of polymer in that case is 50 to 98 wt %.

The flame retardant combination is used more preferably in the polymeric molding composition in a total amount of 10 to 30 wt %, based on the polymeric molding composition. The amount of polymer in that case is 70 to 90 wt %.

The polymer moldings, films, filaments and fibers preferably comprise the flame retardant/stabilizer combination in a total amount of 2 to 50 wt %, based on the polymer content. The amount of polymer in that case is 50 to 98 wt %.

The polymer moldings, films, filaments and fibers more preferably comprise the flame retardant combination in a total amount of 10 to 30 wt %, based on the polymer content. The amount of polymer in that case is 70 to 90 wt %.

The aforementioned additives can be introduced into the polymer in a wide variety of different process steps. For instance, it is possible in the case of polyamides to mix the additives into the polymer melt as early as at the start of or at the end of the polymerization/polycondensation or in a subsequent compounding operation. In addition, there are processing operations in which the additives are added only at a later stage. This is practiced especially in the case of use of pigment or additive masterbatches. There is also the possibility of drum application, especially of pulverulent additives, to the polymer pellets, which may be warm as a result of the drying operation.

The polymers are preferably polyamides and copolyamides which derive from diamines and dicarboxylic acids and/or from aminocarboxylic acids or corresponding lactams, such as polyamide 2/12, polyamide 4 (poly-4-aminobutyric acid, Nylon® 4, DuPont), polyamide 4/6 (poly(tetramethyleneadipamide), poly(tetramethyleneadipic diamide), Nylon® 4/6, DuPont), polyamide 6 (polycaprolactam, poly-6-aminohexanoic acid, Nylon® 6, DuPont, Akulon® K122, DSM; Zytel® 7301, DuPont; Durethan® B 29, Bayer), polyamide 6/6 ((poly(N,N′-hexamethyleneadipamide), Nylon® 6/6, DuPont, Zytel® 101, DuPont; Durethan® A30, Durethan® AKV, Durethan® AM, Bayer; Ultramid® A3, BASF), polyamide 6/9 (poly(hexamethylenenonanediamide), Nylon® 6/9, DuPont), polyamide 6/10 (poly(hexamethylenesebacamide), Nylon® 6/10, DuPont), polyamide 6/12 (poly(hexamethylenedodecanediamide), Nylon® 6/12, DuPont), polyamide 6/66 (poly(hexamethyleneadipamide-co-caprolactam), Nylon® 6/66, DuPont), polyamide 7 (poly-7-aminoheptanoic acid, Nylon® 7, DuPont), polyamide 7,7 (polyheptamethylenepimelamide, Nylon® 7,7, DuPont), polyamide 8 (poly-8-aminooctanoic acid, Nylon® 8, DuPont), polyamide 8,8 (polyoctamethylenesuberamide, Nylon® 8,8, DuPont), polyamide 9 (poly-9-aminononanoic acid, Nylon® 9, DuPont), polyamide 9,9 (polynonamethyleneazelamide, Nylon® 9,9, DuPont), polyamide 10 (poly-10-aminodecanoic acid, Nylon® 10, DuPont), polyamide 10,9 (poly(decamethyleneazelamide), Nylon® 10,9, DuPont), polyamide 10,10 (polydecamethylenesebacamide, Nylon® 10,10, DuPont), polyamide 11 (poly-11-aminoundecanoic acid, Nylon® 11, DuPont), polyamide 12 (polylauryllactam, Nylon® 12, DuPont, Grilamid® L20, Ems Chemie), aromatic polyamides originating from m-xylene, diamine, and adipic acid; polyamides prepared from hexamethylenediamine and isophthalic and/or terephthalic acid (polyhexamethyleneisophthalamide polyhexamethyleneterephthalamide) and optionally from an elastomer as modifier, e.g. poly-2,4,4-trimethylhexamethyleneterephthalamide or poly-m-phenyleneisophthalamide. Block copolymers of the abovementioned polyamides with polyolefins, olefin copolymers, ionomers, or chemically bonded or grafted elastomers; or with polyethers, such as with polyethylene glycol, polypropylene glycol or polytetramethylene glycol, for example. Additionally, EPDM-modified or ABS-modified polyamides or copolyamides; and also polyamides condensed during processing (“RIM polyamide systems”).

The polymers are preferably polyureas, polyimides, polyamidimides, polyetherimides, polyesterimides, polyhydantoins, and polybenzimidazoles.

The polymers are preferably polyesters deriving from dicarboxylic acids and dialcohols and/or from hydroxycarboxylic acids or the corresponding lactones, such as polyethylene terephthalate, polybutylene terephthalate (Celanex® 2500, Celanex® 2002, Celanese; Ultradur®, BASF), poly-1,4-dimethylolcyclohexane terephthalate, polyhydroxybenzoates, and also block polyether esters which derive from polyethers having hydroxyl end groups; and also polyesters modified with polycarbonates or with MBS.

The invention finally also relates to a method for producing flame-retarded polymer moldings, wherein flame-retarded polymer molding compositions of the invention are processed by injection molding (e.g. injection molding machine (Aarburg Allrounder type)) and compression, foam injection molding, internal gas pressure injection molding, blow molding, film casting, calendering, laminating or coating at elevated temperatures to give the flame-retarded polymer molding.

Preferably the polyamides are of the amino acid type and/or of the diamine-dicarboxylic acid type.

Preferred polyamides are polyamide-6 and/or polyamide 66, and polyphthalamides.

Preferably the polyamides are unaltered, colored, filled, unfilled, reinforced, unreinforced, or else otherwise modified.

### EXAMPLES

1. Components used
   Commercial polymers (pellets):
   Polyamide 6.6 (PA 6.6-GV): Ultramid® A27 (from BASF AG, D)
   Polyphthalamide (PPA): Vestamid® HT plus M100 (from Evonik, D)
   Glass fibers, PPG HP 3610 EC 10 4.5 mm (from PPG Ind. Fiber Glass, NL)
   Flame retardant (component A)):
   Aluminum salt of diethylphosphinic acid, referred to hereinafter as DEPAL
   Flame retardant (component B)):
   Aluminum salt of phosphorous acid, referred to hereinafter as PHOPAL
   Anticorrosion additives (component C)):
   Zinc borate Firebrake® ZB and Firebrake® 500, from Borax, USA
   Zinc stannate Flamtard® H and Flamtard® S, from William Blythe, UK
   Boehmites: Disperal® 20, Siral® 10, Pural® SB, from Sasol, D
   Chalk: Hakuenka® CC-R, from Omya,

### Component D):

Melamine polyphosphate (referred to as MPP), Melapur® 200 (from BASF, D)
Phosphonites (component E)): Sandostab® P-EPQ, from Clariant GmbH, D
Wax components (component F)):
Licowax® E, from Clariant Produkte (Deutschland) GmbH, D (ester of montan wax acid)
2. Production, processing, and testing of flame-retardant polymeric molding compositions

The flame retardant components were mixed with the phosphonite, the lubricants and stabilizers in the ratio specified in the table and incorporated via the side intake of a twin-screw extruder (Leistritz ZSE 27/44D) into PA 6.6 at temperatures of 260 to 310° C., and into PPA at 300-340° C. The glass fibers were added via a second side intake. The homogenized polymer strand was drawn off, cooled in a water bath and then pelletized.

After sufficient drying, the molding compositions were processed to test specimens on an injection molding machine (Arburg 320 C Allrounder) at melt temperatures of 250 to 340° C., and tested and classified for flame retardancy using the UL 94 test (Underwriter Laboratories).

The UL 94 fire classifications are as follows:
V-0: afterflame time never longer than 10 sec, total of afterflame times for 10 flame applications not more than 50 sec, no flaming drops, no complete consumption of the specimen, afterglow time for specimens never longer than 30 sec after end of flame application
V-1: afterflame time never longer than 30 sec after end of flame application, total of afterflame times for 10 flame applications not more than 250 sec, afterglow time for specimens never longer than 60 sec after end of flame application, other criteria as for V-0
V-2: cotton ignited by flaming drops, other criteria as for V-1 Not classifiable (ncl): does not comply with fire classification V-2.

The flowability of the molding compositions was determined by finding the melt volume flow rate (MVR) at 275° C./2.16 kg. A sharp rise in the MVR value indicates polymer degradation. MVR is also affected by fillers.

Tensile strength (N/mm²), elongation at break, and breaking strength were measured according to DIN EN ISO 527(%), impact strength [kJ/m²] and notched impact strength [kJ/m²] in accordance with DIN EN ISO 179.

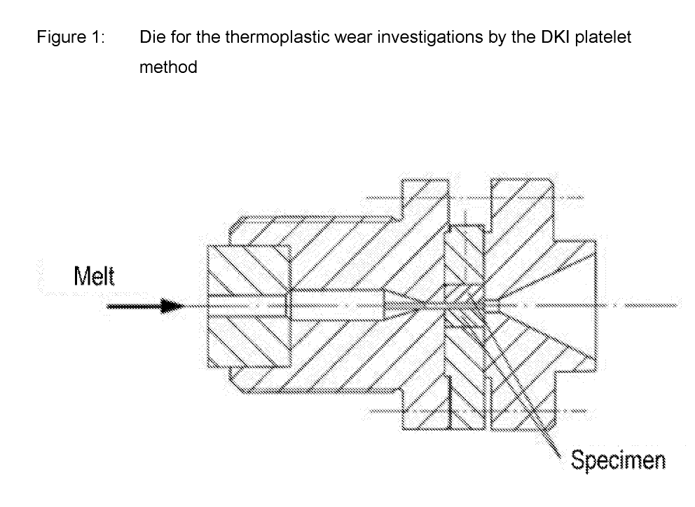

The corrosion was investigated by means of the platelet method. The platelet method, developed at the DKI (Deutsches Kunststoffinstitut, Darmstadt, Germany), serves for the model investigations for comparative evaluation of metallic materials and, respectively, the corrosion intensity and wear intensity of plastifying molding compositions. In this testing, two specimens are arranged in pairs in the die, so as to form a rectangular gap of 12 mm in length, 10 mm in width, and with a height of 0.1 up to a maximum of 1 mm adjustable height for the passage of the polymeric melt (FIG. 1). Through this gap, polymeric melt from a plastifying assembly is extruded (or injected), with large local shear stresses and shear rates occurring in the gap.

One parameter of wear is the weight loss of the specimens, which is determined by differential weighing of the specimens using an A&D analytical “Electronic Balance” with a deviation of 0.1 mg. The mass of the specimens was determined before and after the corrosion test, with 25 kg of polymer throughput on 1.2379 steel or 10 kg on CK 45 steel.

After a previously defined throughput (generally 25 or 10 kg), the sample platelets are demounted and are cleaned physically/chemically to remove the adhering polymer. Physical cleaning is accomplished by removing the hot polymer mass by rubbing it off with a soft material (cotton). Chemical cleaning is done by heating the specimens for 20 minutes at 60° C. in m-cresol. Polymeric composition still adhering after the boiling operation is removed by being rubbed off with a soft cotton pad.

All tests in the particular series, unless stated otherwise, were conducted under identical conditions (temperature programs, screw geometries, injection molding parameters, etc.) on account of comparability.

All quantities are reported as wt % and are based on the polymeric molding composition including the flame retardant combination and adjuvants.

Table 1 shows polyamide molding compositions which comprise component A) and component B) as a flame retardant mixture. These compositions exhibit significantly measurable corrosion.

TABLE 1
PA 66 GF 30 comparative examples with
DEPAL and DEPAL/PHOPAL mixtures.

| | C1 | C2 | C3 | C4 | C5 |
|---|---|---|---|---|---|
| Polyamide 66 | 49.7 | 50 | 50 | 50 | 50 |
| Glass fibers | 30 | 30 | 30 | 30 | 30 |
| Component A): DEPAL | 20 | 17.5 | 18.75 | 16.25 | 15 |
| Component B): PHOPAL | | 2.5 | 1.25 | 3.75 | 5 |
| Component F): Licowax E | 0.3 | 0.3 | | | |
| UL 94 1.6 mm | ncl. | V-0 | V-0 | V-0 | V-0 |
| UL 94 0.8 mm | V-1 | V-0 | V-0 | V-0 | V-0 |
| Corrosion on 1.2379 steel [%] | 0.2 | 0.2 | 0.25 | 0.21 | 0.26 |
| MVR [g/10 min] | 4.8 | | | | |
| Tensile strength [N/mm²] | 146 | 148 | | | |
| Elongation at break [%] | 2.9 | 2.7 | | | |
| IS [kJ/mm²] | 67 | 63 | | | |
| NIS [kJ/mm²] | 8.9 | 9.4 | | | |

Table 2 sets out comparative examples C6 to C12, in which the flame retardant mixture used was based on the aluminum salt of diethylphosphinic acid (DEPAL) and the nitrogen-containing synergist melamine polyphosphate (MPP). The polyamide molding compositions exhibit high corrosion with DEPAL and MPP. On addition of zinc borate and stabilizers and/or zinc stannate, the corrosion can be lowered significantly. Boehmites as well lead to a reduction in corrosion. Nevertheless, the loss of mass from the steel platelets, caused by corrosion, remains measurable.

TABLE 2
PA 66 GF 30 comparative examples C6-C10 with DEPAL/MPP mixtures

| | C6 | C7 | C8 | C9 | C10 | C11 | C12 |
|---|---|---|---|---|---|---|---|
| Polyamide 66 | 50.7 | 49.7 | 49.4 | 49.7 | 49.7 | 49.7 | 49.7 |
| Glass fibers | 30 | 30 | 30 | 30 | 30 | 30 | 30 |
| Component A): DEPAL | 12 | 12 | 12 | 11.5 | 11.5 | 11 | 11 |
| Component D): MPP | 7 | 7 | 7 | 6.5 | 6.5 | 5 | 5 |
| Component C): zinc borate | | 1 | 1 | 1 | 1 | 1 | 1 |
| Component C): Flamtard H | | | | 1 | | | |
| Component C): Flamtard S | | | | | 1 | | |
| Component C): Siral 10 | | | | | | 3 | |
| Component C): Pural SB | | | | | | | 3 |
| Component F): Licowax E | 0.3 | 0.3 | 0.3 | 0.3 | 0.3 | 0.3 | 0.3 |
| Component E): P-EPQ + O10 | | | 0.3 | | | | |
| UL 94 1.6 mm | V-0 | V-0 | V-0 | V-0 | V-0 | V-0 | V-0 |
| UL 94 0.8 mm | V-0 | V-0 | V-0 | V-1 | V-1 | V-1 | V-1 |
| Impact strength [kJ/m²] | n.d. | 60 | n.d. | 59 | 61 | 63 | 59 |
| Notched impact strength [kJ/m²] | n.d. | 12 | n.d. | 13 | 14 | 8.5 | 8.1 |
| Corrosion on 1.2379 steel [%] | 1.9 | 0.42 | 0.46 | 0.24 | 0.18 | 0.02 | 0.06 |
| MVR [g/10 min] | n.d. | 12.3 | n.d. | 17.5 | 15.4 | 3.7 | 7.1 |

Table 3 shows, as comparative examples, glass fiber-reinforced PA 66 compound formulations which comprise a DEPAL/PHOPAL mixture and non zinc-containing additives. These additives do reduce the corrosion, but still always show a measurable loss of mass from the steel platelets.

TABLE 3
PA 66 GF30 comparative examples C13-C17 with DEPAL/PHOPAL
mixture and non-zinc-containing anticorrosion additives.

| | C13 | C14 | C15 | C16 | C17 |
|---|---|---|---|---|---|
| Polyamide 66 | 49.55 | 49.55 | 49.55 | 49.55 | 49.55 |
| Glass fibers | 30 | 30 | 30 | 30 | 30 |
| Component A): DEPAL | 15 | 15 | 15 | 15 | 16 |
| Component B): PHOPAL | 3 | 3 | 3 | 3 | 2 |
| Component C): Chalk | | 1 | | | |
| Component C): Pural SB | | | 3 | | |
| Component C): Siral 10 | | | | 3 | |
| Component C): Disperal 20 | | | | | 3 |
| Component F): Licowax E | 0.3 | 0.3 | 0.3 | 0.3 | 0.3 |
| UL 94 1.6 mm | V-0 | V-0 | V-0 | V-0 | V-0 |
| UL 94 0.8 mm | V-0 | V-0 | V-0 | V-1 | V-1 |
| MVR 275° C./2.16 kg | 5 | 4 | 2.3 | 1.3 | 1.7 |
| Corrosion on 1.2379 steel [%] | 0.20 | n.d. | 0.20 | 0.26 | 0.29 |
| Corrosion on CK4 steel [%] | 0.16 | 0.16 | n.d. | n.d. | n.d. |
| Impact strength [kJ/m²] | 63 | 60 | 61 | 65 | 62 |
| Notched impact strength[kJ/m²] | 15 | 16 | 14 | 15 | 11 |

TABLE 4
Inventive: PA 66 GF30 trial results B1-B5 with DEPAL/PHOPAL
mixture and zinc-containing corrosion additives.

| | B1 | B2 | B3 | B4 | B5 |
|---|---|---|---|---|---|
| Polyamide 66 | 48.7 | 48.7 | 49.7 | 48.7 | 48.7 |
| Glass fibers | 30 | 30 | 30 | 30 | 30 |
| Component A): DEPAL | 15 | 15.5 | 15.5 | 15.5 | 15.5 |
| Component B): PHOPAL | 3 | 3.5 | 3.5 | 3.5 | 3.5 |
| Component C): Flamtard S | 3 | 2 | 1 | | |
| Component C): Flamtard H | | | | 2 | |
| Component C): zinc borate | | | | | 2 |
| Component F): Licowax E | 0.3 | 0.3 | 0.3 | 0.3 | 0.3 |
| UL 94 1.6 mm | V-0 | V-0 | V-0 | V-0 | V-0 |
| UL 94 0.8 mm | V-1 | V-0 | V-0 | V-0 | V-1 |
| MVR 275° C./2.16 kg | 6.1 | 3.6 | 3.2 | 3.9 | 0.6 |
| Corrosion on 1.2379 steel [%] | 0.00 | 0.00 | 0.00 | 0.00 | 0.10 |
| Tensile strength [N/mm²] | 144 | 145 | 147 | 147 | 149 |
| Elongation at break [%] | 2.6 | 2.6 | 2.7 | 2.6 | 2.7 |
| Impact strength [kJ/m²] | 64 | 59 | 64 | 63 | 67 |
| Notched impact strength[kJ/m²] | 8.3 | 8.3 | 8.4 | 8.1 | 9.4 |

Table 4 shows the polyamide molding compositions B1 to B5 of the invention. When these molding compositions, comprising a DEPAL-PHOPAL mixture and additionally zinc-containing anticorrosion additives, are processed, it is not possible to measure any losses of mass from the platelets in the corrosion test. Moreover, the molding compositions comply with exacting fire protection requirements in accordance with UL 94, and exhibit good mechanical properties.

TABLE 5
PPA GF30 with flame retardant (comparative
C13 and inventive example B6).

| | C13 | B6 |
|---|---|---|
| PPA | 55 | 52 |
| Glass fibers | 30 | 30 |
| Component A): DEPAL | 12 | 12 |
| Component B): PHOPAL | 3 | 3 |
| Component C): Flamtard S | | 3 |
| Corrosion on 1.2379 steel [%] | 0.41 | 0.00 |
| UL 94 0.8 mm | V-0 | V-0 |
| UL 94 1.6 mm | V-0 | V-0 |
| Tensile strength [N/mm²] | 179 | 159 |
| Elongation at break [%] | 2.4 | 2.1 |
| Impact strength [kJ/m²] | 74 | 60 |
| Notched impact strength[kJ/m²] | 6.6 | 6.3 |

Table 5 shows in direct comparison a DEPAL-PHOPAL-comprising PPA molding composition C13 and a PPA molding composition of the invention which comprises zinc stannate as well as DEPAL-PHOPAL. Through the addition of zinc stannate, it was possible to reduce the corrosion caused by DEPAL-PHOPAL to such a significant extent that loss of mass from the platelets was no longer measurable in the corrosion test. The molding composition of the invention meets exacting fire protection requirements in accordance with UL 94 and exhibits good mechanical properties.

1. A noncorrosive flame retardant mixture comprising
as component A) 20 to 98.9 wt % of a dialkylphosphinic salt of the formula (I), a diphosphinic salt of the formula (II), polymers thereof or a combination thereof, 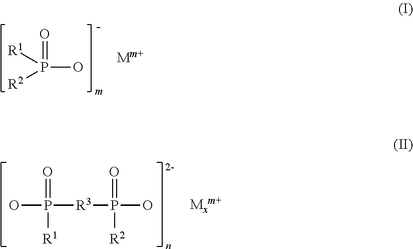
wherein
R¹, R² are identical or different and are C₁-C₆-alkyl, linear or branched;
R³ is C₁-C₁₀-alkylene, linear or branched, C₆-C₁₀-arylene, C₇-C₂₀-alkylarylene or C₇-C₂₀-arylalkylene;
M is Mg, Ca, Al, Sb, Sn, Ge, Ti, Zn, Fe, Zr, Ce, Bi, Sr, Mn, Li, Na, K, a protonated nitrogen base or a combination thereof;
m is 1 to 4;
n is 1 to 4;
x is 1 to 4,
as component B) 1 to 80 wt % of a salt of phosphorous acid having the formula (III)
[HP(═O)O₂]²⁻M^{m+} (III)
wherein
M is Mg, Ca, Al, Sb, Sn, Ge, Ti, Zn, Fe, Zr, Ce, Bi, Sr, Mn, Li, Na, K or a combination thereof,
as component C) 0.1 to 30 wt % of an inorganic zinc compound,
as component D) 0 to 30 wt % of a nitrogen-containing synergist, a phosphorus/nitrogen flame retardant or a combination thereof,
as component E) 0 to 3 wt % of a phosphonite or of a mixture of a phosphonite and a phosphite, and
as component F) 0 to 3 wt % of an ester or salt of long-chain aliphatic carboxylic acids (fatty acids), having a chain length of C₁₄ to C₄₀, the sum of the components always being 100 wt %.

2. The noncorrosive flame retardant mixture as claimed in claim 1, wherein R¹, R² in formula (I) and (II) are identical or different and are methyl, ethyl, n-propyl, isopropyl, n-butyl, tert-butyl, n-pentyl, phenyl or a combination thereof.

3. The noncorrosive flame retardant mixture as claimed in claim 1, wherein R³ is methylene, ethylene, n-propylene, isopropylene, n-butylene, tert-butylene, n-pentylene, n-octylene, n-dodecylene; phenylene, naphthylene; methylphenylene, ethylphenylene, tert-butylphenylene, methylnaphthylene, ethylnaphthylene, tert-butylnaphthylene; phenylmethylene, phenylethylene, phenylpropylene or phenylbutylene.

4. The noncorrosive flame retardant mixture as claimed in claim 1, wherein the mixture comprises
60 to 89.8 wt % of component A),
10 to 40 wt % of component B),
0.1 to 20 wt % of component C),
0 to 20 wt % of component D),
0 to 2 wt % of component E) and
0.1 to 2 wt % of component F).

5. The noncorrosive flame retardant mixture as claimed in claim 1, wherein the mixture comprises
60 to 84.9 wt % of component A),
10 to 40 wt % of component B),
5 to 20 wt % of component C),
0 to 10 wt % of component D),
0 to 2 wt % of component E) and
0.1 to 2 wt % of component F).

6. The noncorrosive flame retardant mixture as claimed in claim 1, wherein the mixture comprises
60 to 84.8 wt % of component A),
10 to 40 wt % of component B),
5 to 20 wt % of component C),
0 to 10 wt % of component D),
0.1 to 2 wt % of component E) and
0.1 to 2 wt % of component F).

7. The noncorrosive flame retardant mixture as claimed in claim 1, wherein the mixture comprises
60 to 83.8 wt % of component A),
10 to 40 wt % of component B),
5 to 20 wt % of component C),
1 to 10 wt % of component D),
0.1 to 2 wt % of component E) and
0.1 to 2 wt % of component F).

8. The noncorrosive flame retardant mixture as claimed in claim 1, wherein component B) comprises reaction products of phosphorous acid with aluminum compounds.

9. The noncorrosive flame retardant mixture as claimed in claim 1, wherein component B) is aluminum phosphite [Al(H₂PO₃)₃], secondary aluminum phosphite [Al₂(HPO₃)₃], basic aluminum phosphite [Al(OH)(H₂PO₃)₂*2aq], aluminum phosphite tetrahydrate [Al₂(HPO₃)₃*4aq], aluminum phosphonate, Al₇(HPO₃)₉(OH)₆(1,6-hexanediamine)_{1.5}*12H₂O, Al₂(HPO₃)³*xAl₂O₃*nH₂O with x=1-2.27 and n=1-50, Al₄H₆P₁₆O₁₈ or a combination thereof, or is an aluminum phosphite of the formulae (XII), (XIII), (XIV), or a combination thereof, wherein
formula (XII) is: Al₂(HPO₃)₃x(H₂O)_{q}
and
q is 0 to 4;
formula (XIII) is Al_{2.00}M_{z}(HPO₃)_{y}(OH)ᵥx(H₂O)_{w}
and
M is alkali metal ions,
z is 0.01 to 1.5,
y is 2.63 to 3.5,
v is 0 to 2, and
w is 0 to 4;
formula (XIV) is Al_{2.00}(HPO₃)ᵤ(H₂PO₃)ₜx(H₂O)ₛ
and
u is 2 to 2.99 and
t is 2 to 0.01 and
s is 0 to 4,
or the aluminum phosphite is a mixture of aluminum phosphite of the formula (XII) with sparingly soluble aluminum salts and nitrogen-free foreign ions, mixtures of aluminum phosphite of the formula (XIII) with aluminum salts, mixtures of aluminum phosphites of the formulae (XII) to (XIV) with aluminum phosphite [Al(H₂PO₃)₃], with secondary aluminum phosphite [Al₂(HPO₃)₃], with basic aluminum phosphite [Al(OH)(H₂PO₃)₂*2aq], with aluminum phosphite tetrahydrate [Al₂(HPO₃)₃*4aq], with aluminum phosphonate, with Al₇(HPO₃)₉(OH)₆(1,6-hexanediamine)_{1.5}*12H₂O, with Al₂(HPO₃)₃*xAl₂O₃*nH₂O with x=1-2.27 and n=1-50, with Al₄H₆P₁₆O₁₈ or a combination thereof.

10. The noncorrosive flame retardant mixture as claimed in claim 1, wherein component C) is zinc oxide, zinc hydroxide, tin oxide hydrate, zinc borate, basic zinc silicate, zinc stannate or a combination thereof.

11. The noncorrosive flame retardant mixture as claimed in claim 1, wherein component D) is a condensation product of melamine, reaction products of melamine with polyphosphoric acid, reaction products of condensation products of melamine with polyphosphoric acid, or mixtures thereof; or is melem, melam, melon, dimelamine pyrophosphate, melamine polyphosphate, melem polyphosphate, melam polyphosphate, melon polyphosphate, mixed polysalts thereof or a combination thereof; or comprises is a nitrogen-containing phosphate of the formulae (NH₄)_{y} H_{3-y} PO₄, (NH₄ PO₃)_{z} or a combination thereof, where y is 1 to 3 and z is 1 to 10000.

12. The noncorrosive flame retardant mixture as claimed in claim 1, wherein the phosphonites are of the formula (IV)
R—[P(OR₁)₂]ₘ (IV)
wherein
R is a mono- or polyvalent aliphatic, aromatic or heteroaromatic organic radical and
R₁ is a compound of the structure (V) 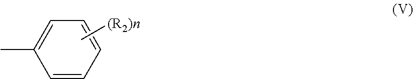
or the two radicals R₁ form a bridging group of the structure (VI) 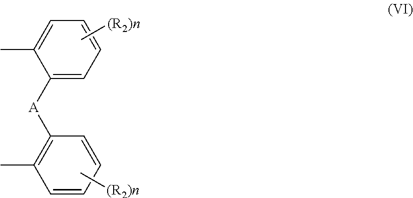
wherein
A is direct bond, O, S, C₁-C₁₈-alkylene (linear or branched), C₁-C₁₈-alkylidene (linear or branched),
wherein
R₂ independently at each occurrence is C₁-C₁₂-alkyl (linear or branched), C₁-C₁₂-alkoxy, C₅-C₁₂-cycloalkyl, and
n is 0 to 5, and
m is 1 to 4.

13. The noncorrosive flame retardant mixture as claimed in claim 1, wherein component F is an alkali metal, alkaline earth metal, aluminum and/or zinc salts of long-chain fatty acids having 14 to 40 carbon atoms, reaction products of long-chain fatty acids having 14 to 40 carbon atoms with polyhydric alcohols or a combination thereof.

14. The noncorrosive flame retardant mixture as claimed in claim 1, wherein the mixture is incorporated into a polymer.

15. The noncorrosive flame retardant mixture as claimed in claim 14, wherein the polymer is selected from the group consisting of polyesters, polyamides, polymer blends comprising polyamides or polyesters and a combination thereof.

16. The noncorrosive flame retardant mixture as claimed in claim 14, wherein the polymer is one or more polyamides, and, optionally, fillers, reinforcing agents or a combination thereof.

17. The noncorrosive flame retardant mixture as claimed in claim 16, wherein the polyamides are in the form of moldings, films, filaments, fibers or a combination thereof.

18. The noncorrosive flame retardant mixture as claimed in claim 16 comprising
30-93 wt % of polyamide
2-40 wt % of the mixture of the plurality of components A) to F)
5-50 wt % of fillers, reinforcing agents or a combination thereof
0-40 wt % of further additives.
